(19) United States
(12) Patent Application Publication
(10) Pub. No.: US 2025/0282303 A1
(43) Pub. Date: Sep. 11, 2025

(54) CAMERA MOUNTING DEVICE AND VEHICLE

(71) Applicant: CARIAD (CHINA) CO., LTD., Beijing (CN)

(72) Inventors: Shehryar KHAN, Beijing (CN); Yuchen SHAO, Beijing (CN)

(21) Appl. No.: 19/039,180

(22) Filed: Jan. 28, 2025

(30) Foreign Application Priority Data
Jan. 29, 2024 (CN) 202420215246.X

(51) Int. Cl. B60R 11/04; B60R 11/00

(52) U.S. Cl. CPC B60R 11/04; B60R 2011/0026; B60R 2011/0059

(57) ABSTRACT

The present disclosure provides a camera mounting device that comprises: a baseplate in which at least one capture opening is disposed; and spring members, wherein each capture opening corresponds to at least two spring members, the at least two spring members are arranged to be located on two sides, respectively, of an axis of the capture opening in the baseplate. A camera is sandwiched between the at least two spring members, and a lens of the camera faces the capture opening. The camera mounting device of the disclosure does not need an extra support, thereby simplifying a mounting structure and mounting steps, reducing the cost and realizing stable securing of the camera.

### TECHNICAL FIELD

The present disclosure relates to the technical field of vehicle manufacturing, and in particular, to a camera mounting device and a vehicle.

### BACKGROUND

At present, in order to mount a narrow-angle camera and a wide-angle camera on a vehicle, the camera will be mounted on a bonding plate using a front camera support and a retainer, and then the bonding plate is adhered to a windshield, where a wiring harness/wire of the camera is mounted in the support. The existing camera mounting means has the following disadvantages: an extra support needs to be arranged to mount the camera to the bonding plate, leading to complicated mounting steps; the support is large and wide and occupies a large space, leading to a large size of the bonding plate; the wiring harness/wire of the camera is prolonged, needing larger space for housing; and a thermal pad inside the retainer dissipates heat, causing a bad thermal effect to the support structure.

Therefore, there is a need for an improved camera mounting device to overcome or reduce at least some of the disadvantages existing in the prior art hereinabove.

### SUMMARY

In a first aspect of the disclosure, there is provided a camera mounting device which comprises:
a baseplate in which at least one capture opening is disposed; and
spring members, wherein each capture opening corresponds to at least two spring members, the at least two spring members are arranged to be located on two sides, respectively, of an axis of the capture opening in the baseplate; and a camera is sandwiched between the at least two spring members, and a lens of the camera faces the capture opening and aligns with the capture opening.

Optionally, the camera mounting device comprises a protruding portion that is formed by extending along a direction away from a surface of the baseplate, wherein the spring members are disposed on the protruding portion, and a recessed structure is formed on the protruding portion and is configured to house the camera.

Optionally, the protruding portion comprises a first wall and a second wall that are arranged to be located on two sides, respectively, of the axis of the capture opening in the baseplate, wherein the spring members are disposed, one on either of the first wall and the second wall, and the recessed structure is formed between the first wall and the second wall.

Optionally, a rib is formed inside the recessed structure.

Optionally, the protruding portion further comprises third walls that are formed on the sides of the first wall and the second wall, away from the capture opening, respectively, wherein the distance between a top surface of the first wall and the baseplate and the distance between a top surface of the second wall and the baseplate gradually decrease in a direction away from the third walls and towards the capture opening, so that the camera is angled with respect to the baseplate.

Optionally, the distance between the first wall and the second wall is 26.5 mm-28 mm; and/or
an included angle between the camera and the baseplate is 21°-23°.

Optionally, the spring members are flat spring members.

Optionally, each of the flat spring members comprises a first section and a second section, the first section of each of the flat spring members extends along a direction away from the surface of the baseplate, and the second section of each of the flat spring members extends from an end of the first section of the flat spring member towards the flat spring member on the other side of the axis of the capture opening.

In a second aspect of the disclosure, there is provided a vehicle which comprises the aforesaid camera mounting device.

Optionally, the vehicle comprises a windshield, and the camera mounting device is attached to the windshield via the baseplate.

The camera mounting device of the disclosure is arranged to comprise the baseplate and the spring members, and the at least two spring members are arranged to be located on two sides, respectively, of the axis of the capture opening in the baseplate, so that the camera can be directly attached to the baseplate by being sandwiched between the at least two spring members. Hence, no extra support needs to be disposed, thereby simplifying the mounting structure and mounting steps and reducing the cost. In addition, the camera is sandwiched and secured between the spring members, so that the camera is stably secured. With the deformation of the spring members, the camera can be easily removed from the baseplate. Furthermore, the camera is directly attached to the baseplate, so that no thermal effect is generated, while the wiring arrangement of the camera is simpler.

Specific embodiments of the disclosure will be described in detail below with reference to the drawings. Those skilled in the art will further understand the described and other purposes, advantages and features of the disclosure.

### BRIEF DESCRIPTION OF THE DRAWINGS

Features, advantages and exemplary implementations of the disclosure will be described below with reference to the drawings. In the drawings, the same reference numerals indicate the same elements, wherein:

FIG. 1 is a schematic structural diagram of a camera mounting device according to an embodiment of the disclosure on a windshield during use.

FIG. 2 is a perspective structural diagram of the camera mounting device of FIG. 1 on the windshield during use.

FIG. 3 is a partial exploded perspective structural diagram of the camera mounting device of FIG. 1.

FIG. 4 is a schematic diagram of a process of mounting a camera to the camera mounting device of FIG. 1.

FIG. 5 is another schematic diagram of a process of mounting a camera to the camera mounting device of FIG. 1.

### DETAILED DESCRIPTION OF THE EMBODIMENTS

Exemplary implementations of the disclosure will be described below in detail with reference to the drawings. The description of the exemplary implementation is merely illustrative and in no way serves as any limitation to the disclosure and application or usage thereof. Moreover, the size and scale of each component in the drawings are merely schematic and in no way strictly correspond to actual products.

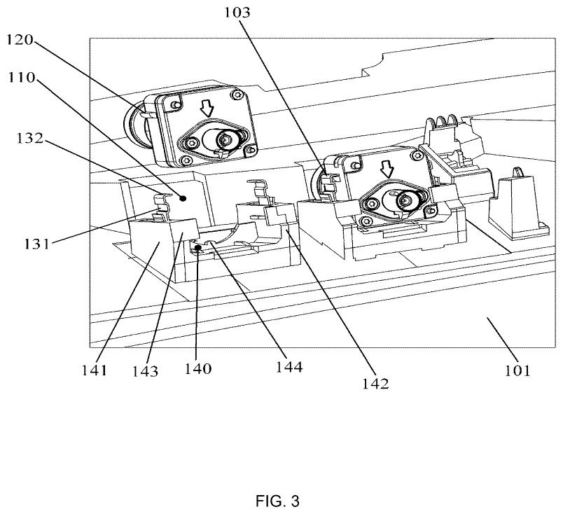

The disclosure provides a camera mounting device. The camera mounting device comprises: a baseplate 101 and spring members 103. At least one capture opening 110 is disposed in the baseplate 101 (see FIG. 3). Each capture opening 110 corresponds to at least two spring members 103, the at least two spring members 103 are arranged to be located on two sides, respectively, of an axis of the capture opening 110 in the baseplate 101; and a camera 102 is sandwiched between the at least two spring members 103, and a lens of the camera 102 faces the capture opening 110 and aligns with the capture opening 110. The camera mounting device of the embodiment of the disclosure is arranged to comprise the baseplate 101 and the spring members 103, and the at least two spring members 103 are arranged to be located on two sides, respectively, of the axis of the capture opening 110 in the baseplate 101, so that the camera 102 can be directly attached to the baseplate 101 by being sandwiched between the at least two spring members 103. Hence, no extra support needs to be disposed, thereby simplifying the mounting structure and mounting steps and reducing the cost. In addition, the camera 102 is sandwiched and secured between the spring members 103, so that the camera 102 is stably secured. An extra protective cover or the like needs not to be added on the camera 102. With the deformation of the spring members 103, the camera 102 can be easily removed from the baseplate 101. Moreover, the camera 102 is directly attached to the baseplate 101, so that no thermal effect is generated, and the wiring arrangement of the camera 102 is simpler. It can be understood that the camera mounting device is applicable to any apparatus or transportation means in which the camera 102 needs to be mounted, including, but not limited to, a vehicle, an autonomous mobile robot, a self-service robot, etc.

The disclosure further provides a vehicle that has the aforesaid camera mounting device. In particular, the vehicle comprises a windshield 200, and the camera mounting device is attached to the windshield 200 via the baseplate 101. The baseplate 101 is generally adhered to the windshield 200. It can be understood that the baseplate 101 may also be attached by other fixation modes, for example, suctioned to the windshield 200 via a suction disk. By adhering the camera mounting device to the windshield 200, the stable and simple arrangement of the front camera 102 can be realized. The vehicle may be a vehicle with an advanced driver assistance system (ADAS), or vehicles other than a vehicle with an ADAS.

Constitution or the like of the camera mounting device of the embodiment of the disclosure will be introduced below in further detail with reference to the drawings. In each drawing, the windshield 200 is only partially shown.

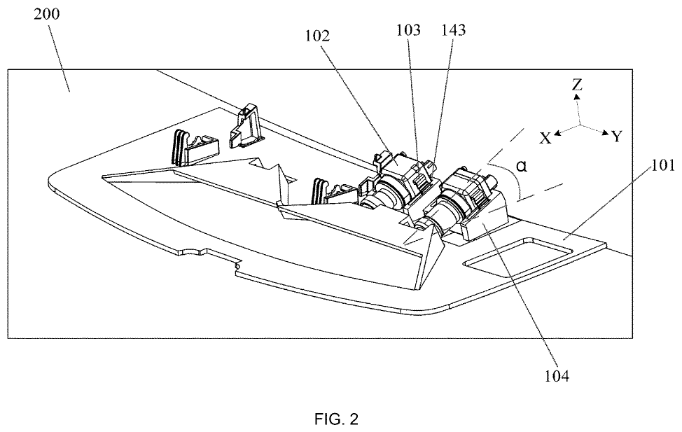

For ease of description, in FIG. 2, an X direction, a Y direction and a Z direction are shown. In an example where the camera mounting device is adhered to the windshield 200 of the vehicle, the X direction is roughly parallel to a vertical height direction of the windshield 200, the Y direction is roughly parallel to a horizontal length direction of the windshield 200, and the Z direction is roughly perpendicular to the X direction and the Y direction. In addition, an included angle α between the axis of the capture opening 110 and the X direction is roughly shown by dotted lines in FIG. 2, which is also an included angle α between the axis of the camera 102 and the baseplate 101. Furthermore, the descriptions such as “upper”, “lower”, “left” and “right” used herein also take the example of adhering the camera mounting device to the windshield 200 of the vehicle.

The number of capture openings 110 disposed in the baseplate 101 may be one or more, for example, one, two or four. For each capture opening 110, one camera 102 is disposed correspondingly. The camera 102 may be generally classified into a narrow-angle camera or a wide-angle camera.

Each capture opening 110 corresponds to at least two spring members 103 that are arranged to be located on two sides, respectively, of an axis of the capture opening 110 in the baseplate 101. In other words, in the Y direction, at least one spring member 103 should be disposed on each of left and right sides of the capture opening 110, such that when the camera 102 is sandwiched between these spring members 103, a lens of the camera 102 can face the capture opening 110 and align with the capture opening 110. The spring members 103 hold the camera 102 mainly in the Z direction. In general, the lens of the camera 102 directly faces the capture opening 110, and the axis of the capture opening 110 overlaps the axis of the camera 102. For example, each capture opening 110 corresponds to two spring members 103, one of which is located on the left side of the axis of the capture opening 110, and the other one of which is located on the right side of the axis of the capture opening 110. For another example, each capture opening 110 corresponds to three spring members 103, two of which are located on the left side of the axis of the capture opening 110, and the rest one of which is located on the right side of the axis of the capture opening 110.

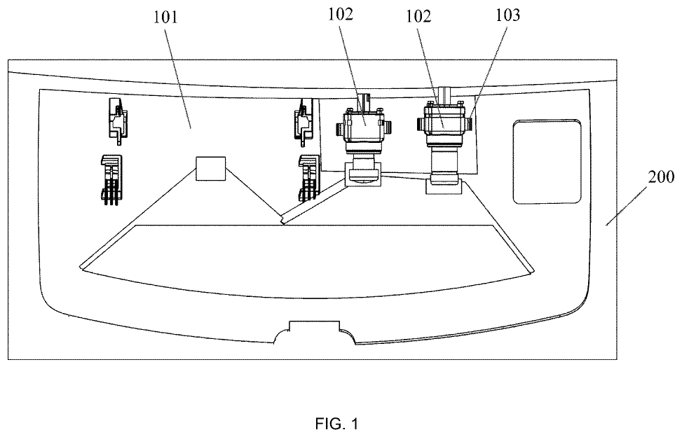

In the camera mounting device of the embodiment shown in FIGS. 1 and 2, two capture openings 110 are disposed in the baseplate 101. Above each capture opening 110, two spring members 103 are symmetrically disposed on the left and right sides, respectively, of the axis of the capture opening 110. Each of the two cameras 102 is sandwiched between the two corresponding spring members 103, and the lens of each camera 102 faces its corresponding capture opening 110. The two cameras 102 may be a narrow-angle camera and a wide-angle camera respectively, which are used for visual monitoring in front of the vehicle.

In some embodiments, the spring members 103 may be flat spring members. With the flat spring members 103, the distance between the two flat spring members disposed oppositely can increase by bending the flat spring members outwards, so that the camera 102 is easy to remove. Meanwhile, the flat spring members have simple structures and thus can be easily fixed to the baseplate 101. In general, the spring members 103 that are made of a metal material are aesthetics and durable. It can be understood that the spring members 103 made of other materials may also be used.

FIG. 3 is a partial exploded perspective structural diagram of the camera mounting device of FIG. 1. Referring to FIG. 3, in a preferred implementation, each flat spring member may comprise a first section 131 and a second section 132, the first section 131 of each flat spring member extends along a direction away from the surface of the baseplate 101, and the second section 132 of each flat spring member extends from an end of the first section 131 of the flat spring member towards the flat spring member on the other side of the axis of the capture opening 110. Each flat spring member is arranged to comprise the first section 131 and the second section 132. Once the camera 102 is inserted between the two flat spring members facing each other, the second sections 132 of the flat spring members will be released on an outer surface of the camera 102 and apply pressure to the outer surface of the camera 102. In addition, a clamping force between the two second sections 132 facing each other is large, thereby ensuring stable securing of the camera 102. In addition, in order to further improve stable securing, bulged portions 120 may be formed on the outer surface of the camera 102. The bulged portions 120 are configured to match with the second sections 132, such that once the camera 102 is inserted between the two flat spring members facing each other, the second sections 132 of the flat spring members will be released on the bulged portions 120 of the camera 102 and secured together with the camera 102. With reference to FIG. 2, the first section 131 is formed by extending from the baseplate 101 roughly in the Z direction, and the second section 132 is formed by extending from an end of the first section 131 of one spring member 103 towards one side of the other spring member 103. The first section 131 may be of a straight structure or a bent structure. As shown in FIG. 3, the first section 131 preferably is of a bent structure. Compared with a straight structure, the bent first section 131 may provide higher clamping and deformation capabilities.

In some embodiments, the camera mounting device of the embodiment of the disclosure may comprise a protruding portion 104 that is formed by extending along a direction away from the surface of the baseplate 101, wherein the spring members 103 are disposed on the protruding portion 104, and a recessed structure 140 is formed on the protruding portion 104 and is configured to house the camera 102. With the protruding portion 104 on which the recessed structure 140 configured to house the camera 102 is formed, the camera 102 may be properly angled with respect to the baseplate 101. Meanwhile, with the matching between the recessed structure 140 and the spring members 103, the camera 102 can be stabilized better. In the embodiment shown in FIGS. 1 and 2, the camera mounting device comprises two protruding portions 104, with one protruding portion 104 corresponding to one capture opening 110 and one camera 102. The protruding portion 104 is formed by extending towards one side of the interior of the vehicle roughly in the Z direction.

As can be seen from FIGS. 2 and 3, the protruding portion 104 may comprise a first wall 141 and a second wall 142 that are arranged to be located on two sides, respectively, of the axis of the capture opening 110 in the baseplate 101, wherein the spring members 103 are disposed, one on either of the first wall 141 and the second wall 142, and the recessed structure 140 is formed between the first wall 141 and the second wall 142. With the first wall 141 and the second wall 142 that match with the spring members 103, the position of the camera 102 on the baseplate 101 can remain unchanged, thereby firmly securing the camera 102 and not allowing the camera 102 to move. It can be understood that adjacent protruding portions 104 may share a wall when a plurality of protruding portions 104 are disposed. The spring members 103 and the protruding portion 104 are assembled into a whole. Referring to FIG. 3, clamp slots may be provided in the first wall 141 and the second wall 142. A clamp rod is disposed in each clamp slot. The flat spring members are bent through the clamp rods in the clamp slots, so that the flat spring members are fixed to the protruding portion 104.

In some embodiments, a rib 144 may be formed inside the recessed structure 140. The rib 144 helps to slide and securing of the surface of the camera 102. In order to better fit with the camera 102, an arc-shaped surface is generally formed inside the recessed structure 140. The recessed structure 140 may form the arc-shaped surface as a whole, or a structure with an arc-shaped surface may be formed inside the recessed structure 140. In the embodiment shown in FIG. 3, a structure with an arc-shaped surface is formed inside the recessed structure 140 by extending between the first wall 141 and the second wall 142 along a direction away from the surface of the baseplate 101, and a rib 144 is formed on the structure. At the recessed structure 140, a plurality of ribs 144, for example, three ribs, may be disposed at intervals between the first wall 141 and the second wall 142. The rib 144 generally has a smooth top surface.

The protruding portion 104 may further comprise third walls 143 that are formed on sides of the first wall 141 and the second wall 142, away from the capture opening 110, respectively, wherein the distance between a top surface of the first wall 141 and the baseplate and the distance between a top surface of the second wall 142 and the baseplate 101 gradually decrease in a direction away from the third walls 143 and towards the capture opening 110, so that the camera 102 is angled with respect to the baseplate 101. With the third walls 143, better stability and securing position may be provided for the camera 102. For example, as can be seen from FIG. 3, the third walls 143 may lean against a back surface of the camera 102. Meanwhile, the first wall 141 and the second wall 142 are configured into a slope structure, so that the camera 102 may be disposed obliquely relative to the baseplate 101. In this way, the lens of the camera 102 is better oriented towards the capture opening 110 and aligned with the capture opening 110. As shown in FIGS. 1 and 2, the first wall 141, the second wall 142 and the third walls 143 are formed by extending towards one side of the interior of the vehicle roughly in the Z direction, the first wall 141 and the second wall 142 are symmetrically located on the left and right sides of the axis of the capture opening 110 along the Y direction, and the third walls 143 are formed towards each other on the sides of the first wall 141 and the second wall 142 away from the capture opening 110.

The distance between the first wall 141 and the second wall 142 may be 26.5 mm-28 mm, for example, 26.5 mm, 27.8 mm and 28 mm. The structures of a plurality of protruding portions 104 on the same baseplate 101 may be identical. That is, the distance between the first wall 141 and the second wall 142 is the same. In this case, a mounting space for the camera is adjustable using the elasticity of the spring members 103 so as to fit with the camera 102 of different sizes. Of course, the structures of a plurality of protruding portions 104 on the same baseplate 101 may be different.

Generally, an included angle between the camera 102 and the baseplate 101 may be 21°-23°, for example, 21°, 22° and 23°.

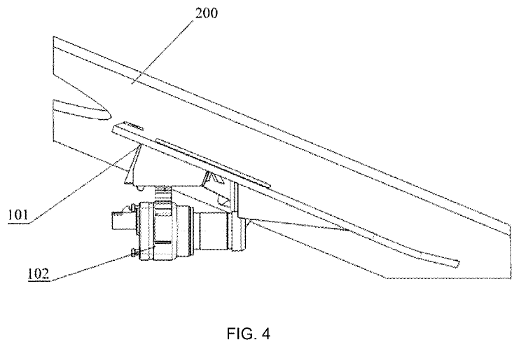

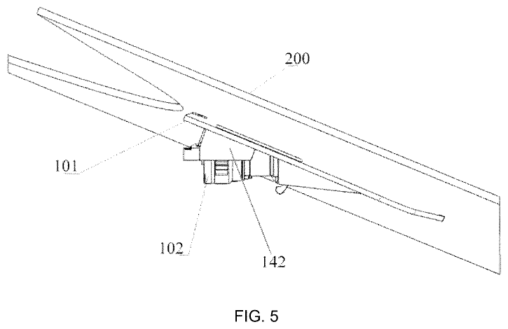

FIG. 4 is a schematic diagram of a process of mounting a camera 102 to the camera mounting device of FIG. 1. FIG. 5 is another schematic diagram of a process of mounting a camera 102 to the camera mounting device of FIG. 1. FIGS. 1 and 2 are schematic diagrams after the camera 102 is mounted. When the camera mounting device of the embodiment of the disclosure is used in the vehicle, the camera 102 is inserted in the Z direction between the two spring members 103 and further inserted until the camera 102 is housed in the recessed structure 140. Then, the baseplate 101 is attached to the windshield 200, thus completing the mounting of the front camera 102. When the camera mounting device of the embodiment of the disclosure is used in the vehicle, it is also possible to first attach the baseplate 101 to the windshield 200, then insert the camera 102 in the Z direction between the two spring members 103 and further insert until the camera 102 is housed in the recessed structure 140, thus completing the mounting of the front camera 102. In FIG. 4, the camera 102 is to be inserted between the two spring members 103. In FIG. 5, the camera 102 is already inserted between the two spring members 103 and housed in the recessed structure 140.

In the description of this specification, the reference to the terms “one implementation”, “some implementations”, “one embodiment”, “some embodiments” or “preferred implementations” means that the specific features, structures, materials or characteristics described in view of the embodiment or example are included in at least one embodiment or example of the disclosure. In this specification, the schematic expressions of these terms do not necessarily refer to the same embodiment or example. Moreover, the specific features, structures, materials, or characteristics described can be combined in any one or more embodiments or examples in an appropriate manner.

Implementations of the disclosure are described in detail above. However, the aspects of the disclosure are not limited to the implementations hereinabove. Various modifications and substitutions may be applied to the implementations hereinabove without departing from the scope of the disclosure.

1. A camera mounting device, wherein the camera mounting device comprises:
a baseplate in which at least one capture opening is disposed; and
spring members, wherein each capture opening corresponds to at least two spring members, the at least two spring members are arranged to be located on two sides, respectively, of an axis of the capture opening in the baseplate; and a camera is sandwiched between the at least two spring members, and a lens of the camera faces the capture opening and aligns with the capture opening.

2. The camera mounting device according to claim 1, wherein:
the camera mounting device comprises a protruding portion that is formed by extending along a direction away from a surface of the baseplate, wherein the spring members are disposed on the protruding portion, and a recessed structure is formed on the protruding portion and is configured to house the camera.

3. The camera mounting device according to claim 2, wherein:
the protruding portion comprises a first wall and a second wall which are arranged to be located on two sides, respectively, of the axis of the capture opening in the baseplate, wherein the spring members are disposed, one on either of the first wall and the second wall, and the recessed structure is formed between the first wall and the second wall.

4. The camera mounting device according to claim 2, wherein:
a rib is formed inside the recessed structure.

5. The camera mounting device according to claim 3, wherein:
the protruding portion further comprises third walls which are formed on the sides of the first wall and the second wall, away from the capture opening, respectively, wherein the distance between a top surface of the first wall and the baseplate and the distance between a top surface of the second wall and the baseplate gradually decrease in a direction away from the third walls and towards the capture opening, so that the camera is angled with respect to the baseplate.

6. The camera mounting device according to claim 5, wherein:
the distance between the first wall and the second wall is 26.5 mm-28 mm; and/or
an included angle between the camera and the baseplate is 21°-23°.

7. The camera mounting device according to claim 1, wherein the spring members are flat spring members.

8. The camera mounting device according to claim 7, wherein:
each of the flat spring members comprises a first section and a second section, the first section of each of the flat spring members extends along a direction away from the surface of the baseplate, and the second section of each of the flat spring members extends from an end of the first section of the flat spring member towards the flat spring member on the other side of the axis of the capture opening.

9. A vehicle, wherein the vehicle has a camera mounting device, and the camera mounting device comprises:
a baseplate in which at least one capture opening is disposed; and
spring members, wherein each capture opening corresponds to at least two spring members, the at least two spring members are arranged to be located on two sides, respectively, of an axis of the capture opening in the baseplate; and a camera is sandwiched between the at least two spring members, and a lens of the camera faces the capture opening and aligns with the capture opening.

10. The vehicle according to claim 9, wherein:
the vehicle comprises a windshield, and the camera mounting device is attached to the windshield via the baseplate.

11. The vehicle according to claim 9, wherein:
the camera mounting device comprises a protruding portion that is formed by extending along a direction away from a surface of the baseplate, wherein the spring members are disposed on the protruding portion, and a recessed structure is formed on the protruding portion and is configured to house the camera.

12. The vehicle according to claim 11, wherein:
the protruding portion comprises a first wall and a second wall which are arranged to be located on two sides, respectively, of the axis of the capture opening in the baseplate, wherein the spring members are disposed, one on either of the first wall and the second wall, and the recessed structure is formed between the first wall and the second wall.

13. The vehicle according to claim 11, wherein:
a rib is formed inside the recessed structure.

14. The vehicle according to claim 12, wherein:
the protruding portion further comprises third walls which are formed on the sides of the first wall and the second wall, away from the capture opening, respectively, wherein the distance between a top surface of the first wall and the baseplate and the distance between a top surface of the second wall and the baseplate gradually decrease in a direction away from the third walls and towards the capture opening, so that the camera is angled with respect to the baseplate.

15. The vehicle according to claim 14, wherein:
the distance between the first wall and the second wall is 26.5 mm-28 mm; and/or an included angle between the camera and the baseplate is 21°-23°.

16. The vehicle according to claim 9, wherein the spring members are flat spring members.

17. The vehicle according to claim 16, wherein:
each of the flat spring members comprises a first section and a second section, the first section of each of the flat spring members extends along a direction away from the surface of the baseplate, and the second section of each of the flat spring members extends from an end of the first section of the flat spring member towards the flat spring member on the other side of the axis of the capture opening.
